(19) United States
(12) Patent Application Publication
(10) Pub. No.: US 2023/0028776 A1
(43) Pub. Date: Jan. 26, 2023

(54) METHOD FOR MANUFACTURING EYEGLASS FOR PROVIDING LIGHT TO AN EYE, BLANK AND SET OF EYEGLASSES

(71) Applicants: CARL ZEISS AG, Oberkochen (DE); NANO-RETINA, INC., Wilmington, DE (US)

(72) Inventors: Günter RUDOLPH, Jena (DE); Thomas NOBIS, Leipzig (DE); Tobias SCHMITT-MANDERBACH, Kempten (DE); Matthias HILLENBRAND, Jena (DE); Leonid YANOVITZ, Rishon LeZion (IL); Ofir RIMER-COHEN, Zelafon (IL); Ben SAAR, Tel Aviv (IL)

(73) Assignees: CARL ZEISS AG, Oberkochen (DE); NANO-RETINA, INC., Wilmington, DE (US)

(21) Appl. No.: 17/786,863

(22) PCT Filed: Dec. 20, 2019
(86) PCT No.: PCT/EP2019/086600

§ 371 Date: Jun. 17, 2022

(51) Int. Cl. G02B 27/01

(52) U.S. Cl. CPC G02B 27/0172; G02B 2027/0178

(57) ABSTRACT

Methods of manufacturing eyeglasses are provided. The method may include providing a blank (63) with an outcoupling element (25) and machining the blank to provide a light receiving surface based on the at least one physiological parameter. Corresponding blanks and sets of eyeglasses are also provided.

### TECHNICAL FIELD

The present application relates to a method for manufacturing an eyeglass configured to provide light to an eye, a blank for manufacturing an eyeglass e.g. usable in such a method, and a set of corresponding eyeglasses. Furthermore, the application relates to eyewear including such an eyeglass.

### BACKGROUND

In various applications, eyeglasses are used to guide light to an eye of a person. For example, for some head-up displays, light may be modulated according to symbols, images, letters or other information to be displayed, coupled into an eyeglass lens and outcoupled to be guided to an eye of a person, who can then see the information displayed. In this case, the light is in the visible spectrum.

In another application, light is guided to the eye of a patient to provide an active eye implant with energy. For example, there have been attempts to provide persons with degenerative diseases of the retina which cause a loss or a significant reduction of eyesight with retina implants similar to an image sensor of a digital camera, to provide at least some measure of seeing ability. Such implants also comprise a solar cell-like element, which converts received light to electrical energy supplying the implant. In some applications, infrared light is coupled into an eyeglass, and outcoupled from the eyeglass towards the eye of the patient equipped with the retina implant to supply the same with energy. Such a supplying of a retina implant with energy is described for example in DE 103 15 397 A1, DE 10 2016 103 285 A1 or DE 10 2017 107 346 A1. Similar techniques may be used for other active eye implants than retina implants.

In such applications, it is important that light is guided to the eye very precisely. For example, for charging a retina implant, the light has to pass through the pupil of the eye, and an imprecise positioning—for example, of an outcoupling element of the eyeglass—may prevent this.

This requires adapting the eyeglasses to the geometry of the head of the person for which it is intended, for example to parameters like the head width (commonly abbreviated ED; ear distance; it may be measured from ear to ear) or the interpupillary distance (commonly abbreviated PD). These parameters may vary greatly from person to person. For example, ED may vary between 141 mm and 155 mm, and PD may very between 58 mm and 70 mm, just to give some numerical examples.

Therefore, an efficient way to manufacture eyeglasses for providing light to an eye for persons having various head geometries would be desirable.

### SUMMARY

A method as defined in claim 1, a blank as defined in claim 11, and a set of eyeglasses as defined in claim 17 are provided. The dependent claims define further embodiments.

According to an embodiment, a method for manufacturing an eyeglass is provided, comprising:

providing a blank, the blank comprising an outcoupling element configured to couple light out from the blank,

receiving at least one physiological parameter,

machining the blank based on the at least one physiological parameter to provide a light receiving surface configured to receive light to be coupled into the machined blank.

By using such a method including a blank and a separate light forming component, based on the blank and the light forming component, eyeglasses adapted to various head geometries may be manufactured.

The method may further comprise coupling the light receiving surface to a light forming component.

The light forming component may be independent from the at least one physiological parameter. In this way, the same light forming component may be used for manufacturing a plurality of eyeglasses for persons with different physiological parameters.

The light forming component may be configured to receive light from a light source and to output collimated light to the light receiving surface. In other embodiments, the light forming component may be configured to provide non-collimated light, e.g. focused light.

The blank may comprise a first part including the outcoupling element and a second part.

The second part may be angled with respect to the first part.

The at least one physiological parameter may include an interpupillary distance and a head width, wherein machining the blank comprises machining the first part based only on the interpupillary distance and machining the second part based on both the interpupillary distance and the head width. In such a way, the blank may be machined based on only two physiological parameters.

The light receiving surface is formed in the second part. In this case, in operation, the machined second part guides light to the machined first part.

The at least one physiological parameter comprises one or more of an interpupillary distance, a head width or a distance from a line of side of the side of the head. Other parameters describing dimensions of the head of the person may also be used.

According to another embodiment, a blank is provided, comprising:

a first part including an outcoupling element configured to couple light out from the blank, and

a second part,

wherein the blank is made from a transparent material.

By using such a blank with two parts, an easy translation of head dimensions to machining requirements for the blank may be obtained. Therefore, based on such a blank, eyeglasses for persons with varying head geometries may be manufactured.

The second part may be angled with respect to the first part.

An angle between the first part and the second part may be between 5° and 45°.

The blank may be circular or elliptical in a top view.

The outcoupling element may comprise one or more of a holographic element, a reflective surface, a refractive surface or a Fresnel surface.

Any of the blanks described above may be used in the methods described above.

A set of eyeglasses is provided, each eyeglass comprising:

a first component, comprising an outcoupling element configured to couple light out from the first component towards an eye, and a light receiving surface, and

a light forming component configured to receive light from a light source, wherein dimensions of the first component vary between different eyeglasses of the set of eyeglasses.

The first components may each comprise a first part including the outcoupling element and a second part including the light receiving surface, wherein the second part is angled with respect to the first part.

The light forming component may be the same light forming component for each eyeglass of the set of eyeglasses. This may facilitate manufacturing of the set.

Eyeglasses manufactured or provided as explained above may be used to supply an active eye implant with energy, but are not limited to such applications.

### BRIEF DESCRIPTION OF THE DRAWINGS

FIG. 1 is a flowchart illustrating a method according to an embodiment.

FIG. 2A is a cross-sectional side view of a blank according to an embodiment.

FIG. 2B is a top view of the blank of a FIG. 2A.

FIG. 2C is a perspective view of the blank of FIGS. 2A and 2B.

FIG. 3 is a top view of a head of a person wearing eyewear to explain various physiological parameters.

FIG. 4 is a diagram illustrating light propagation in some embodiments.

FIGS. 5A to 5C illustrate adaptation of the light propagation of FIG. 4 to various physiological parameters.

FIG. 6 illustrates light propagation in some embodiments.

FIG. 7 is a diagram illustrating machining of a blank based on physiological parameters.

FIGS. 8 and 9 are perspective views for explaining machining of blanks based on physiological parameters.

FIG. 10 is a diagram of a light forming component according to an embodiment.

FIGS. 11A to 11C illustrate eyeglasses adapted to different physiological parameters according to some embodiments.

FIG. 12 illustrates eyeglasses adapted to different vertical positions.

### DETAILED DESCRIPTION

In the following, various embodiments will be discussed in detail referring to the attached drawings. These embodiments are given for illustrative purposes only and are not to be taken in a limiting sense.

For example, various embodiments relate to guiding light to an eye of a patient for supplying an active retina implant of the patient. However, this is merely an application example, and embodiments may generally be used in situations where light is to be guided to an eye of a person. Other examples include the providing of information in form of images and the like to an eye of the person, for example in head-up display like devices or supplying other active eye implants than retina implants with energy.

Dimensions, shapes and forms shown in the drawings and explained in the following serve merely as illustrative examples, and shapes, dimensions and forms of embodiments may differ from the one explicitly shown in the figures and explained below.

Features from different embodiments may be combined to form further embodiments unless noted otherwise. Variations and modifications described with respect to one of the embodiments are also applicable to other embodiments and will therefore not be described repeatedly.

Throughout the figures, same reference numerals will be used to refer to the same or similar elements. These elements will therefore not be described repeatedly.

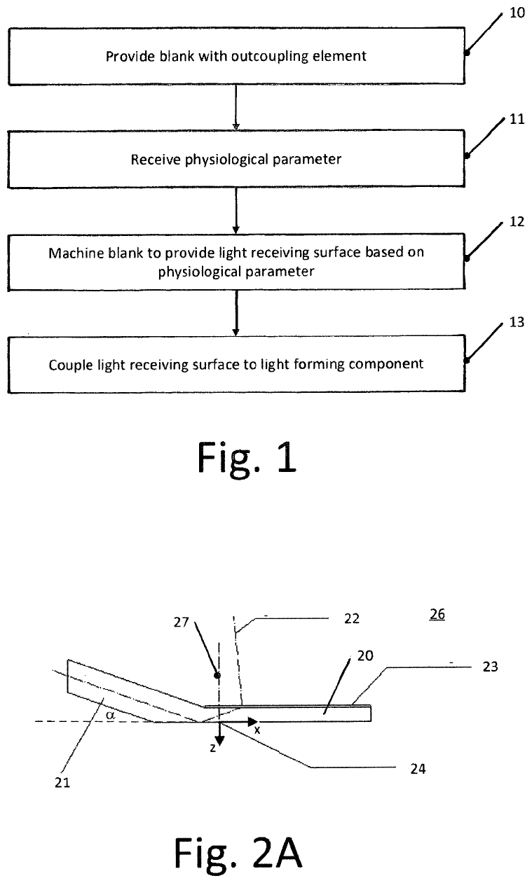

FIG. 1 is a flowchart illustrating a method according to an embodiment. While the method is described as a series of acts or events, the order in which this acts or events are described are not to be construed as limiting. For example, the events at 10 and at 11 in FIG. 1 may also be performed in the reverse order.

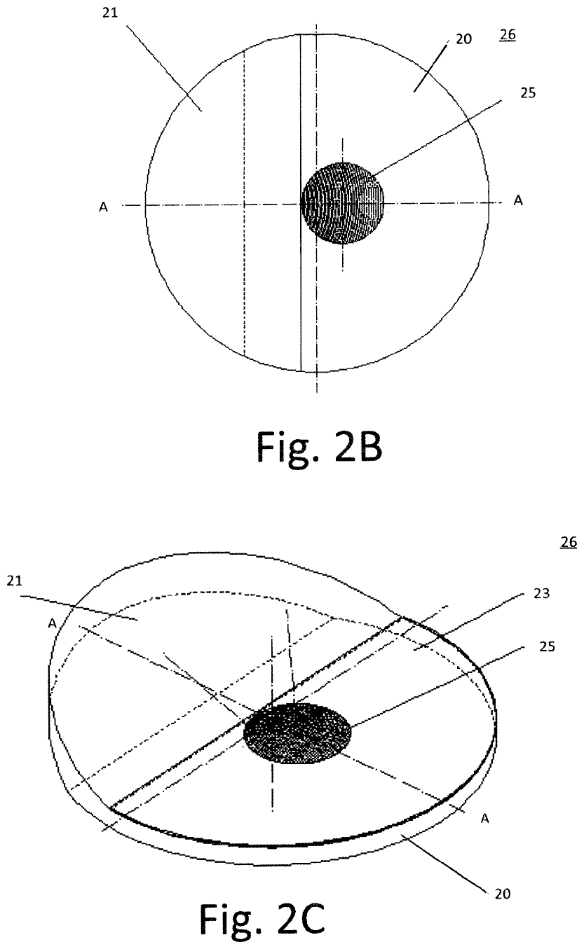

To provide a better understanding, the method of FIG. 1 will be described in conjunction with blanks, eyeglasses, components and other devices shown in FIGS. 2 to 11. However, the method of FIG. 1 and the devices, components, eyeglasses etc. shown in FIGS. 2 to 11 may also be implemented independently from each other.

At 10 in FIG. 1, the method of FIG. 1 comprises providing a blank with an outcoupling element. A blank, as used herein, refers to a transparent body which may be machined to form an eyeglass with a light receiving surface as will be explained further below. The blank as mentioned comprises an outcoupling element which is configured to couple out light guided within the transparent material of the blank towards an eye. Such an outcoupling element may be formed by a holographic element, but is not limited thereto. For example, other diffractive optical elements than holograms or various types of holograms like phase, amplitude or volume holograms (the latter including holograms formed by multiple exposure) may be used. For example, volume holograms may be used to form holographic mirrors for outcoupling. Other examples include Fresnel surfaces in transmission or reflection as described for example in DE 10 2009 010 537 A1 or other reflective or refractive surfaces, meta surfaces or plasmonic surfaces.

In the following, a holographic outcoupling element will be used as an example, with the understanding that embodiments are not limited thereto.

An example for a blank usable in some embodiments is shown in FIGS. 2A to 2C. FIG. 2A shows a cross-sectional view of a blank, FIG. 2B shows a top view of the blank, where the cross-sectional view of FIG. 2A is along a line A-A of FIG. 2B, and FIG. 2C shows a perspective view of the blank. FIGS. 2A to 2C will be collectively referred to as FIG. 2 in the following.

Blank 26 of FIG. 2 comprises a first part 20 and a second part 21. Second part 21 is angled under an angle α with respect to first part 20. α may be for example between 5° and 45°, for example between 5° and 30°, for example about 20°. As will be seen later, after blank 26 is machined, in operation light will pass through the machined second part 21, guided in machined first part 20 and then outcoupled by an outcoupling element. As an example, as an outcoupling element a hologram 25 is formed in a holographic sheet stack 23 (for example light sensitive sheets illuminated and developed accordingly). An example light path is denoted by reference numeral 22 in FIG. 2.

As can be seen in FIG. 2B, in the top view blank 26 has a general circular shape. Other shapes like elliptical shapes are also possible. Reference numeral 27 denotes a middle line which will be used as a reference later on.

The blank 26 of FIG. 2 is merely an example, and other blanks may also be used, provided that based on material removal they may be used to manufacture eyeglasses as detailed further below.

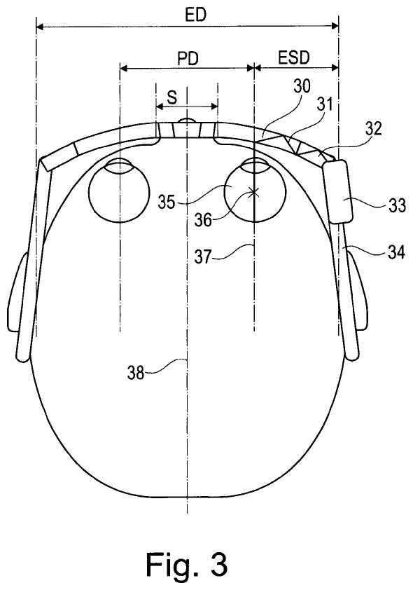

Returning to FIG. 1, at 11 the method comprises receiving at least one physiological parameter of a person the eyeglass to be manufactured is intended for. In the context of the present application, such a physiological parameter is to be understood as a parameter describing a shape, in particular size, of the head of the person and/or a position of pupils of the person. Example physiological parameters will now be described referring to FIG. 3.

FIG. 3 shows a schematic top view of a head 38 of a person wearing eyewear. Eyes 35 of the person are shown, of which a right eye is denoted with reference numerals. Eye 35 has a center point 36, which is approximately the point about which the eye 35 revolves, and a line of sight indicated by reference numeral 37 when looking forward to infinity. A distance between the line of sights 37 for left and right eyes corresponds to the interpupillary distance PD. The head width is denoted ED in FIG. 3 and may be seen as a distance between the ears (ear distance). A distance between an ear and the respective line of sight is denoted ESD, wherein ED−PD=2×ESD. Numeral 38 denotes a center line of the head. A further parameter is the bridge size S, which denotes a distance between the inner edges or rims (the edges near the nose) of the two eyeglasses].

The eyewear shown has temple arms 34, a frame 32, eyeglasses 30 and an illumination device 33. Example light rays are denoted by reference numeral 31. Illumination device 33 comprises at least one light source and generates light which is coupled into eyeglass 30 and then outcoupled towards a respective eye 35. As can be easily understood, the dimensions of the eyewear, and in particular of the eyeglasses have to be adapted to the physiological parameters like PD and ED such that light is outcoupled in the correct position and direction towards the eye 35.

Returning to FIG. 1, at 12 the blank is machined to provide a light receiving surface, where the machining is based on the at least one physiological parameter received at 11. An example for this will be explained in detail referring to FIGS. 4 to 9.

FIG. 4 shows an example for light propagation in an eyewear using eyeglasses manufactured with techniques disclosed herein, for example with the method of FIG. 1.

In the example light propagation shown in FIG. 4, light is generated by a light source 40. For an example application of supplying a retina implant with energy, light source 40 may be an infrared light source like an infrared light emitting diode (LED) or a laser diode. In other applications, other light sources may be used, for example displays.

Light from light source 40 passes into an eyeglass through a surface 41 and is converted into a collimated light bundle by mirrors 42, 43 and 44, where mirrors 42 and 43 may be plane mirrors and mirror 44 may be an aspheric mirror. The collimated light bundle is then reflected by a surface 35, which corresponds to an outer surface of the eyeglass. Outer surface refers to the side of the eyeglass facing away from a person wearing eyewear with the eyeglass in use.

The light is then coupled out of the eyeglass by hologram 25 already explained with reference to FIG. 2 as an example for an outcoupling element, which is provided at an inner surface 46 of the eyeglass. In the example application of FIG. 4, the light then converges towards the cornea and is focused at the center point 36 of the eye, to then illuminate a retina implant 49 in a retina 48 of the eye. Other focusing points, for example a focusing on the pupillary plane of the eye, are also possible in other embodiments.

With 38, again the center line of the head (see FIG. 3) is denoted. A distance B in FIG. 4 essentially corresponds to the distance of center line 38 to center point 36, and a distance A may be approximately the distance between the center point 36 and the ear. As will be explained later, the part where the light beams are parallel will be formed by machining first part 20 of blank 26, and the part where the beams are then reflected and outcoupled will be machined from second part 21 of blank 26, as schematically indicated in FIG. 4.

As can be seen by comparing FIG. 4 with FIG. 3, B corresponds to about half the interpupillary distance PD, and B+A corresponds to about half the head width ED.

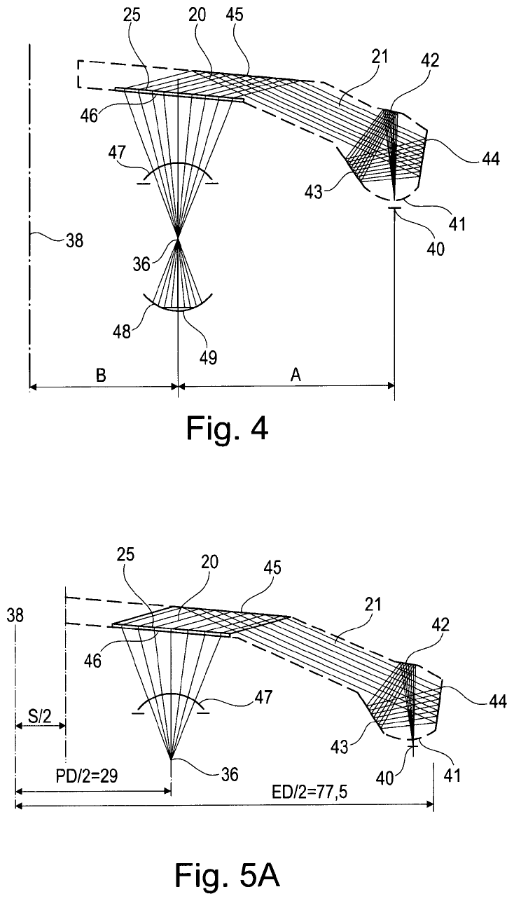

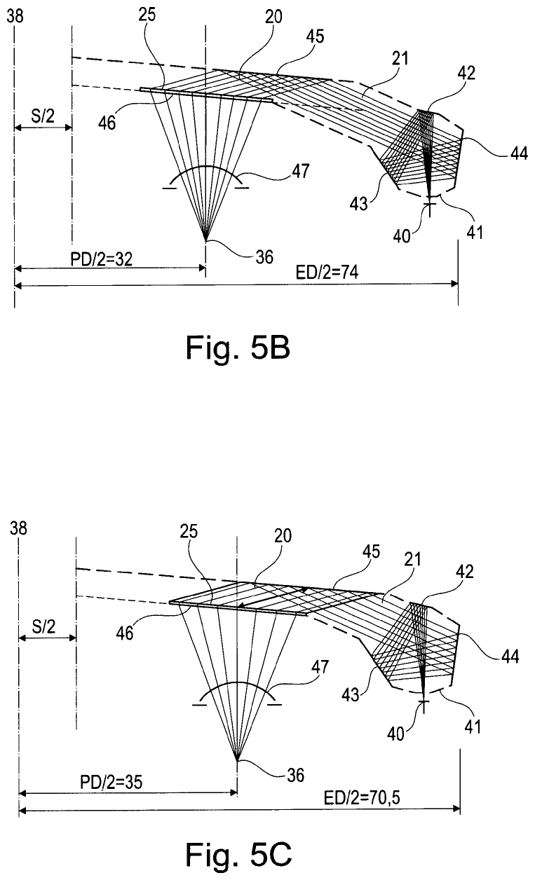

FIGS. 5A to 5C, collectively referred to as FIG. 5, show part of the light propagation of FIG. 4 (up to center point 36) for different values of PD and ED.

FIG. 5A shows a part of FIG. 4 for PD/2=29 mm and ED/2=77.5 mm, FIG. 5B shows this part of FIG. 4 for PD/2=32 mm and ED/2=74 mm, and FIG. 5C shows the part for PD/2=35 mm and ED/2=70.5 mm. As can be seen, the distance from mirrors 42 to 43 to outer surface 45 varies, and also the size of the eyeglass which should reach the distance S/2 shown in FIGS. 5A to 5C needs to vary. On the other hand, the arrangement of mirrors 42, 43, 44 remains constant.

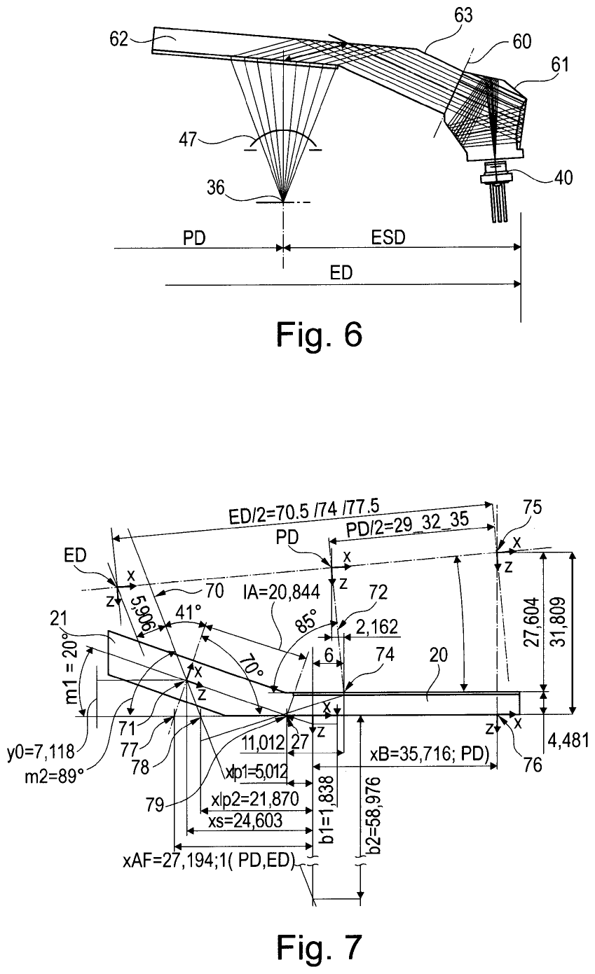

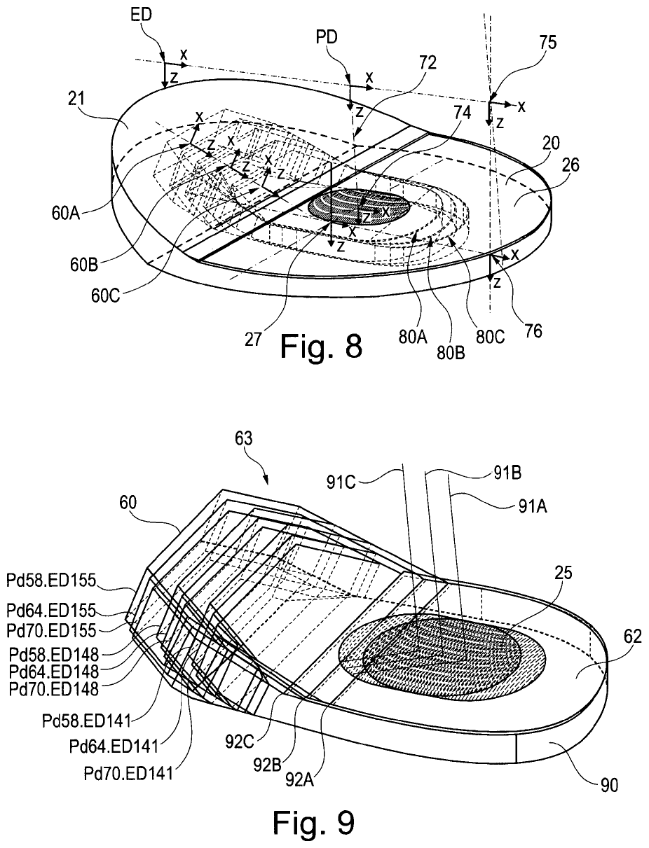

These needed changes in light propagation lead to a machining of blanks of the blank at 12 in FIG. 1 which will be explained further referring to FIGS. 6 to 9. FIG. 6 illustrates a cross-sectional view of a machined blank together with a light forming component, FIG. 7 shows a more detailed cross-sectional view, and FIGS. 8 and 9 show perspective views.

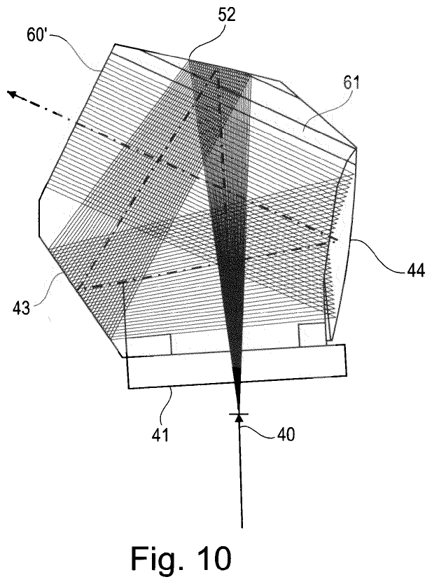

In the cross-sectional view of FIG. 6, first part 20 of the blank is machined to form a part 62 of the eyeglass including an outcoupling element (for example hologram 25 of FIG. 2) which is positioned in front of the user's eye, and second part 21 is machined to form a second part 63 of the eyeglass through which collimated, i.e. parallel, light beams pass. Second part 63 is machined to terminate in a light receiving surface 60, to which then later on a light forming component 61 is coupled which generates collimated light beams in some embodiments. Examples for this light forming component 61 will be explained later with respect to 13 in FIG. 1 and FIG. 10.

As could be seen from FIGS. 5A to 5C, the light forming part of the eyeglass is not changed by varying physiological parameters. By using the light receiving surface 60, the blank may be machined to fit individual physiological parameters, and then the same light forming component may be fitted to the light receiving surface 60. These implementations make manufacturing of eyeglasses and eyewear easier, as the same blank and the same light forming component may be used for a plurality of eyeglasses in some embodiments.

It should be noted that also the position where the light forming component 61 is coupled to the light receiving surface 60 may depend on a physiological parameter, namely the fitting height FH. Generally, a pupil of an eye may be located higher or lower within a spectacle frame, depending e.g. on the relative positions of eyes, nose and ears. For example, when the vertical distance between the eyes and the nose is higher, the pupils will be closer to the upper rim of the eyeglasses or frame for a same eyeglass/frame size than for a lower vertical distance between the eyes and the nose, if the frame always rests on the nose.

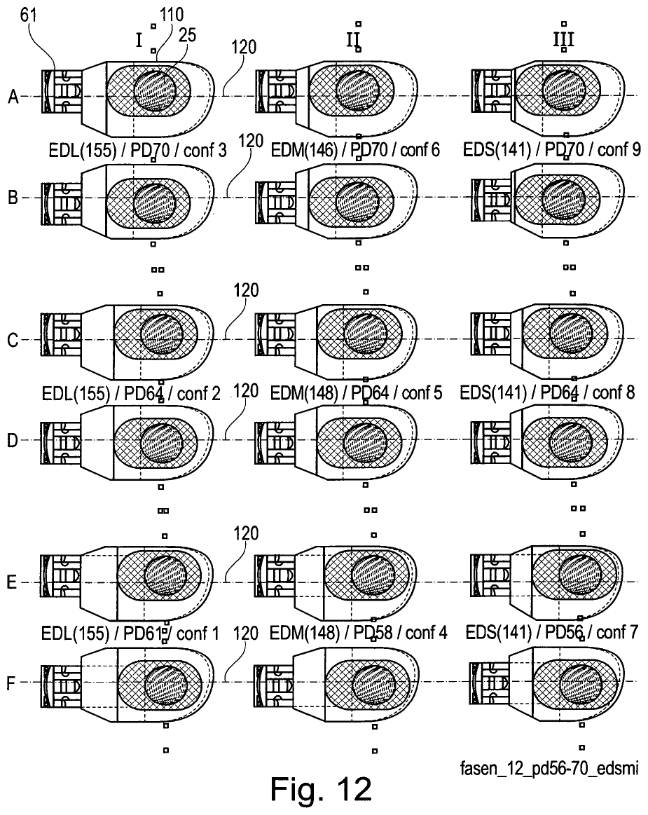

Illustrations for such embodiments are shown in FIG. 12. FIG. 12 shows a plurality of eyeglasses according to various embodiments, which are for ease of reference arranged in rows A to F and columns I to III. Each eyeglass comprises a light forming component 61 and eyeglass 110 formed from a blank as discussed above and including a hologram 25 (denoted only for the eyeglass in row A, column I).

The eyeglasses are provided for different parameters, namely ED=155 mm for column I, ED=148 mm for column II and ED=141 mm for column III, and PD=70 mm for rows A and B, PD=64 mm for rows C and D and PD=61 mm for rows E and F. These different values for ED and PD lead to different eyeglass configurations (conf in FIG. 12).

For each configuration, two different fitting heights are shown (above each other in rows A and B, in rows C and D and in rows E and F), one where the hologram 25 is above a horizontal centerline 120 and one where the hologram 25 is below the horizontal centerline 120. In the embodiments of FIG. 12, the light forming component 61 is positioned on light receiving surface accordingly at an appropriate vertical position.

Deriving dimensions for machining the blank to form first and second parts 62, 63 is shown in more detail in FIG. 7. In FIG. 7, as an example the blank has a diameter of 80 mm. The angle α (see FIG. 2) is 20° in the example of FIG. 7, but may differ in other embodiments. The thickness of first part 20 together with the hologram is about 4.5 mm. In other embodiments, other thicknesses may be used, for example between 3 mm and 5 mm. Generally, while example dimensions are given in FIG. 7, these serve merely for illustrative purposes and may vary for other embodiments. 72 denotes the line of sight for the eyeglass, which forms an angle of about 5° to a line perpendicular on the machined first part 63. A line 71 denotes a position where the light receiving surface 60 is to be machined, and numeral 77 denotes a projection of this line on a horizontal line. A line 70 denotes a reference line for the light forming component When using the formulas specified below for xB=f(PD) and xAF=g(PD, ED), due to the angle α with different values of PD, the position of the light forming component will move along reference line 70. Numeral 78 denotes a corresponding base point. 76 denotes a point where a curve for edging the glass starts, for example a spline curve (will be explained later with reference to FIGS. 8 and 9). Numeral 74 denotes a point where the viewing direction 72 intersects with part 63, and 79 denotes a further reference point regarding the width of the second part to be machined.

The dimension xB in FIG. 7 for the numerical values given may be calculated as a function f(PD) of the interpupillary distance PD as xB=3.594+1.004×PD/2, and a distance xAF may be calculated as a function g(PD, ED) of the interpupillary distance PD and ED according to xAF=−30,812−1.321×PD/2+1.355×ED/2. For other dimensions of the blank, for example other angles α and other thicknesses, other values may apply. However, as can be seen from FIG. 7, the dimensions to which the blank is to be machined may be derived by straightforward geometrical considerations given particular values of PD and ED and a particular blank. It should be noted that some parameters, like the viewing direction 72, may also depend on an eyeglass frame, i.e. under which angle the eyeglass is situated on the head mounted to the eyeglass frame.

FIG. 8 illustrates various dimensions for eyeglasses within a blank as shown in FIG. 2. Numeral 68 denotes the position for the light receiving surface for PD=58 mm and ED=155 mm, numeral 60B denotes the position of the light receiving surface for PD=64 mm and ED=148 mm, and numeral 60C denotes the position of the light receiving surface for PD=70 mm and ED=141 mm. Numeral 80A illustrates an edge of first part 62, which may be in form of a spline curve starting at the point 76 denoted in FIG. 7, for PD=58 mm, numeral 80B denotes the edge for PD=64 mm and numeral 80C shows the edge for PD=70. As can be seen, starting from the same blank, eyeglasses for different head geometries may be manufactured.

FIG. 9 shows corresponding eyeglasses manufactured for various parameters, which are given directly in FIG. 9. As can be seen from the above, first part 62 changes only depending on interpupillary distance PD, while second part 63 changes based on interpupillary distance PD and head width ED. In FIG. 9, the various eyeglasses are depicted such that an edge 90 (corresponding to the edge defined by curves 80A, 80B and 80C of FIG. 8) coincides. It should be noted that the form of edge 90 may be selected depending on an eyeglass used. Numerals 92A denotes a border between the first part 62 and second part 63 for PD=58, numeral 92B for PD=64 and numeral 92C for PD=70 mm. The differing dimensions of first part 62 also shift the position of hologram 25 and the position of a center beam for illumination (essentially corresponding to beam 22 of FIG. 2A exiting the hologram), which are denoted with reference numerals 91A, 91B and 91C for PD=58 mm, 64 mm and 70 mm, respectively.

Sizes of the second part 63 vary depending both on interpupillary distance PD and head width ED, and second part 63 terminating in respective light receiving surfaces 60 are shown for combinations of PD=58 mm, 64 mm, and 70 mm with ED=141 mm, 148 mm and 155 mm.

Returning to FIG. 1, after machining the blank based on the physiological parameters, the light receiving surface is coupled to a light forming component. This has already been briefly shown for light forming component 61 of FIG. 6. This example for a light forming component along with possible variations and modifications will now be further described referring to FIG. 10.

FIG. 10 shows light forming component 61 in the form of a prism. Light forming component 61 receives light from light source 40, for example a light emitting diode, via a first surface 41. The light is then reflected by surfaces 42, 43 which act as plane mirrors to be guided to an aspheric surface 44 serving as an aspheric mirror, which generates a collimated light beam. The light beam then leaves light forming component 61 at a light emitting surface 60′, which is coupled to light receiving surface 60 machined in the blank, such that the light enters second part 63 of the machined blank. As already mentioned, the same light forming component 61 may be used for example for all machined blanks shown in FIG. 9. Nevertheless, in other embodiments, also the light forming component may be adapted to physiological or other parameters. Moreover, the configuration of the light forming component 61 is merely an example. For example, instead of mirrors, other optical elements like spherical or aspherical lenses may be used to form a collimated beam, or combinations of one or more mirrors and one or more lenses may be used. Moreover, depending on the application and configuration, in other embodiments a non-collimated beam may be generated. In some examples, deviations from collimation may then be corrected for example by an additional hologram or other element provided in the machined blank, or the light emission towards the eye may be based on a non-collimated beam. Also, in other embodiments, a different number of mirrors may be used.

In the embodiment of FIG. 10 as well as in some other embodiments, light emitting surface 60′ and light source 40 have a certain angle with each other. The collimated light in embodiments is guided in the right direction to the light emitting surface 60′, and the light source may positioned and oriented parallel to the temples in the final device including the eyeglasses.

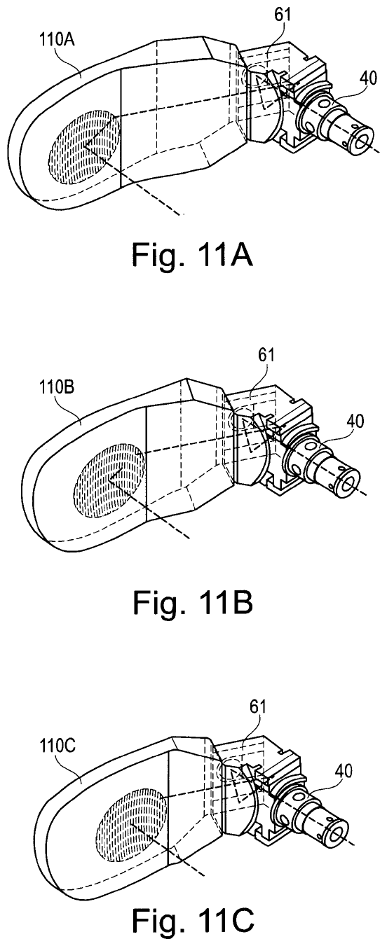

Corresponding eyeglasses together with a light source 40 are shown in FIGS. 11A to 11C for different physiological parameters. The eyeglasses in FIG. 11A to 11C each consist of a machined blank (110A, 110B, 110C, respectively) coupled to light forming component 61 at the light receiving/emitting surfaces 60, 60′, and supplied by light source 40. For machined blank 110A, parameters are PD=58 mm and ED=155 mm, for machined blank 110B, parameters are PD=64 mm and ED=148 mm, and for machined blank 110C, parameters are PD=70 mm and ED=141 mm. It is emphasized again that all numerical values given in the description above serve merely as examples to get a better understanding regarding the application, and in a particular application, depend on the physiological parameters of the person, dimensions of the blank used and possibly also on dimensions of a frame into which the eyeglass is to be fitted.

Also, from the variations and modifications described above, it is evident that the embodiments presented above are merely non-limiting examples and various modifications are possible. For example, while embodiments described above use two components, for example 110 and 61 in FIG. 11, between these components also one or more further components may be provided. In second part 63, besides varying the length, also angles under which light enters second part or leaves second part, position of the light bundle in a direction perpendicular to the optical axis may be used to adapt the eyeglass to physiological parameters. Furthermore, instead of providing second part 63 such that the light bundle simply passes through, in other embodiments, light may also be reflected one or more times within second part 63.

1. A method for manufacturing an eyeglass (110A-C), comprising:
providing a blank (26), the blank (26) comprising an outcoupling element (25) configured to couple light out from the blank (26),
receiving at least one physiological parameter (PD, ED, ESD),
machining the blank (26) based on the at least one physiological parameter (PD, ED, ESD) to provide a light receiving surface (60) configured to receive light to be coupled into the machined blank.

2. The method of claim 1, further comprising coupling the light receiving surface (60) to a light forming component (61).

3. The method of claim 2, wherein the light forming component (61) is independent from the at least one physiological parameter (PD, ED, ESD).

4. The method of claim 2 or 3, wherein the light forming component (61) is configured to receive light from a light source (40) and to output collimated light to the light receiving surface (60).

5. The method of any one of claims 1 to 4, wherein the blank (26) comprises a first part (20) including the outcoupling element (25) and a second part (21).

6. The method of claim 5, wherein the second part (21) is angled with respect to the first part (20).

7. The method of claim 5 or 6, wherein the at least one physiological parameter (PD, ED, ESD) includes an interpupillary distance (PD) and a head width (ED), wherein machining the blank (26) comprises machining the first part (20) based only on the interpupillary distance and machining the second part (21) based on both the interpupillary distance (PD) and the head width (ED).

8. The method of any one of claims 5 to 7, wherein the light receiving surface (60) is formed in the second part (63).

9. The method of any one of claims 1 to 8, wherein the at least one physiological parameter (PD, ED, ESD) comprises one or more of an interpupillary distance (PD), a head width (ED) or a distance from a line of side of the side of the head (ESD).

10. The method of any one of claims 1 to 9, wherein the eyeglass is an eyeglass for supplying an active eye implant (49) with energy.

11. A blank (26), comprising:
a first part (20) including an outcoupling element (25) configured to couple light out from the blank (26), and
a second part (21), wherein the blank (20) is made from a transparent material.

12. The blank (26) according to claim 11, wherein the second part (21) is angled with respect to the first part (20).

13. The blank (26) according to claim 12, wherein an angle between the first part (20) and the second part (21) is between 5° and 45°.

14. The blank (26) of any one of claims 11 to 13, wherein the blank is circular or elliptical in a top view.

15. The blank (26) of any one of claims 11 to 14, wherein the outcoupling element (25) comprises one or more of a holographic element, a reflective surface, a refractive surface or a Fresnel surface.

16. Use of the blank of any one of claims 11 to 15 for manufacturing an eyeglass to supply an active eye implant (49) with energy.

17. A set of eyeglasses, each eyeglass comprising:
a first component (110), comprising an outcoupling element (25) configured to couple light out from the first component (110) towards an eye, and a light receiving surface (60), and a light forming component (61) configured to receive light from a light source (40), wherein dimensions of the first component vary between different eyeglasses of the set of eyeglasses.

18. The set of claim 17, wherein the first components (110) of the eyeglasses each comprise a first part (62) including the outcoupling element (25) and a second part (63) including the light receiving surface (60), wherein the second part (63) is angled with respect to the first part (62).

19. The set of claim 17 or 18, wherein the light forming component (61) is the same light forming component for each eyeglass of the set of eyeglasses.

20. The set of any one of claims 17 to 18, wherein each eyeglass is configured for supplying an active eye implant (49) with energy.
